(19) United States
(12) Patent Application Publication
(10) Pub. No.: US 2009/0284993 A1
(43) Pub. Date: Nov. 19, 2009

(54) Switching power supply circuit

(75) Inventors: Jie-Jian Zheng, Shenzhen (CN); Tong Zhou, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/454,452

(22) Filed: May 18, 2009

(30) Foreign Application Priority Data
May 16, 2008 (CN) 200810067270.9

(51) Int. Cl. H02M 3/335

(52) U.S. Cl. 363/21.08

(57) ABSTRACT

A switching power supply circuit includes a direct current (DC) power supply input; a voltage divider connected between the DC power supply input and ground; a transformer including a primary winding, a secondary winding, and an assistant winding; a pulse generating circuit including a first transistor, a second transistor, an oscillation capacitor, and an oscillation resistor; an output; and a feedback circuit adjusting a duty ratio of a pulse signal in the assistant winding. The DC power supply input is grounded via the primary winding, two conducting electrodes of the second transistor. A control electrode of the second transistor is connected to an output of the voltage divider. An output of the voltage divider is connected to a control electrode of the second transistor and is grounded via two conducting electrodes. A control electrode of the first transistor is grounded via the assistant winding and grounded via the oscillation capacitor and the oscillation resistor connected in series.

### BACKGROUND

1. Technical Field

The present disclosure relates to a switching power supply circuit.

2. Description of Related Art

Switching power supply circuits usually exhibit linear characteristics, have efficient electrical power conversion characteristics, are preferred for use in liquid crystal display TVs, displays, and other consumer devices.

FIG. 3 shows a commonly used switching power supply circuit 1. The switching power supply circuit 1 includes a first rectifying filtering circuit 10, a protection circuit 12, a transformer 13, a second rectifying filtering circuit 143, a third rectifying filtering circuit 144, a feedback circuit 15, a pulse width modulation (PWM) chip 16, a rectifying diode 17, a transistor 18, and a resistor 19.

The PWM chip 16 includes a voltage input 161 receiving an operating voltage, a pulse output 162 generating a pulse signal to a gate electrode of the transistor 18, and a feedback input 163.

The first rectifying and filtering circuit 10 includes two inputs 101, 102 to receive an external alternating current (AC) voltage such as 220V, a full-bridge rectifying circuit 103 to convert the 220V AC voltage to a first direct current (DC) voltage, a first filtering capacitor 104 to stabilize the first DC voltage, and a first output 105 to provide the first DC voltage to the transformer 13. Two inputs of the full-bridge rectifying circuit 103 serve as the two inputs 101, 102. A positive output of the full-bridge rectifying circuit 103 serves as the first output 105. A negative output of the full-bridge rectifying circuit 103 is grounded. The first filtering capacitor 104 is connected between the first output 105 and ground.

The transformer 13 includes a primary winding 131, an assistant winding 132, a first secondary winding 133, and a second secondary winding 134. The primary winding 131 is electrically connected in parallel with the protection circuit 12. One terminal of the primary winding 131 is connected to the first output 105, and the other terminal of the primary winding 131 is connected to a drain electrode of the transistor 18. A source electrode of the transistor 18 is grounded via the resistor 19. A gate electrode of the transistor 18 is connected to the pulse output 162 of the PWM chip 16.

One terminal of the assistant winding 132 is grounded. The other terminal of the assistant winding 132 is connected to the voltage input 161 of the PWM chip 16 via the rectifying diode 17 and a transistor (not labeled) in series.

The second rectifying and filtering circuit 143 includes a second output 141. The third rectifying and filtering circuit 144 includes a third output 142. One terminal of the first secondary winding 133 is coupled to the second output 141 via the second rectifying and filtering circuit 143. The other terminal of the first secondary winding 133 is connected to one terminal of the second secondary winding 134 and to the third output 142 via the third rectifying and filtering circuit 144. The other terminal of the second secondary winding 134 is grounded.

The feedback circuit 15 includes a first voltage division resistor 151, a second voltage division resistor 152, a third voltage division resistor 153, a protection resistor 154, an optical coupler 155, and an adjustable precision shunt regulator 158. One terminal of the first voltage division resistor 151 is connected to the second output 141, and the other terminal of the first voltage division resistor 151 is grounded via the third voltage division resistor 153. One terminal of the second voltage division resistor 152 is connected to the third output 142, and the other terminal of the second voltage division resistor 152 is also grounded via the third division resistor 153.

The optical coupler 155 includes a light emitting diode (LED) 156 and a photoelectric transistor 157. The adjustable precision shunt regulator 158 includes a positive electrode grounded, a reference electrode grounded via the third voltage division resistor 153, and a negative electrode connected to a cathode of the LED 156. An anode of the LED 156 is connected to the third output 142 via a resistor (not labeled). The protection resistor 154 is connected in parallel with the LED 156. One terminal of the photoelectric transistor 157 is grounded, and the other terminal of the photoelectric transistor 157 is connected to the feedback input 163 of the PWM chip 16.

The switching power supply circuit 1 operates as follows:

The external AC voltage is provided to the two inputs 101, 102 of the first rectifying and filtering circuit 10 and is converted to the first DC voltage by the first rectifying and filtering circuit 10. The first DC voltage is provided to the primary winding 131. The assistant winding 132 induces the primary winding 131, generates an operating voltage, and provides the operating voltage to the voltage input 161 of the PWM chip 16 via the rectifying diode 17. Thus, the PWM chip 16 generates the pulse signal for switching the transistor 18 on or off. When the transistor 18 is switched on, a first current path is formed sequentially through the first output 105, the primary winding 131, the transistor 18, and the resistor 19. A first current is formed when the first DC voltage provided to the first output 105 is grounded via the first current path.

When the transistor 18 is switched off, energy stored in the primary winding 131 transfers to the first and the second secondary windings 133, 134. Thus, AC voltages across the first and the second secondary winding 133, 134 are respectively generated. The second rectifying and filtering circuit 143 converts the AC voltage across the first secondary winding 133 to a 14V DC voltage, and provides the 14V DC voltage to the second output 141. The third rectifying and filtering circuit 144 converts the AC voltage across the second secondary winding 134 to a 5V DC voltage, and provides the 5V DC voltage to the second output 142.

When the voltages at the second and the third outputs 141, 142 decrease or increase, the feedback circuit 15 generates a feedback signal according to the variation of the voltages at the second and the third outputs 141, 142, and sends the feedback signal to the PWM chip 16. The PWM chip 16 increases or decreases a duty ratio of the pulse signal according to the received feedback signal. Therefore, a period in which the transistor 18 remains in an activated state is prolonged or shortened, and the voltages respectively at the second and third outputs 142, 143 are increased or decreased. Thus, the switching power supply circuit 1 can substantially output regulated power supply respectively via the second and third outputs 142, 143 to drive a load circuit.

Because the switching power supply circuit 1 includes numerous electric units to cooperate the PWM chip 16, volume of the switching power supply circuit 1 is correspondingly large. Furthermore, cost of the PWM chip is high, increasing the expense of the switching power supply circuit 1.

It is thus desirable to provide a switching power supply circuit which can overcome the described limitations.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a diagram of a switching power supply circuit according to a first embodiment of the disclosure.

FIG. 2 is a diagram of a switching power supply circuit according to a second embodiment of the disclosure.

FIG. 3 shows a diagram of a frequently used switching power supply circuit.

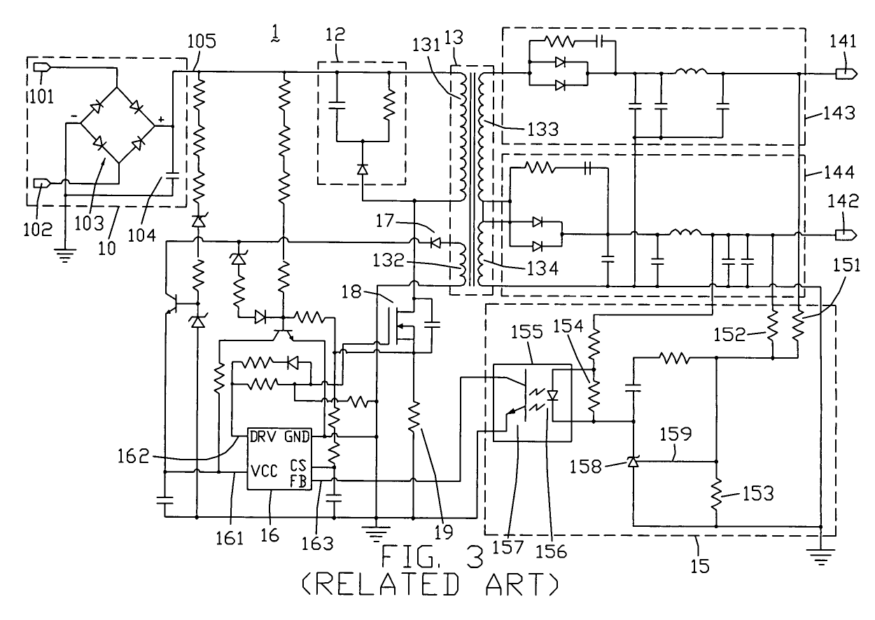

### DETAILED DESCRIPTION

Reference will now be made to the drawings to describe various inventive embodiments of the present disclosure in detail, wherein like numerals refer to like elements throughout.

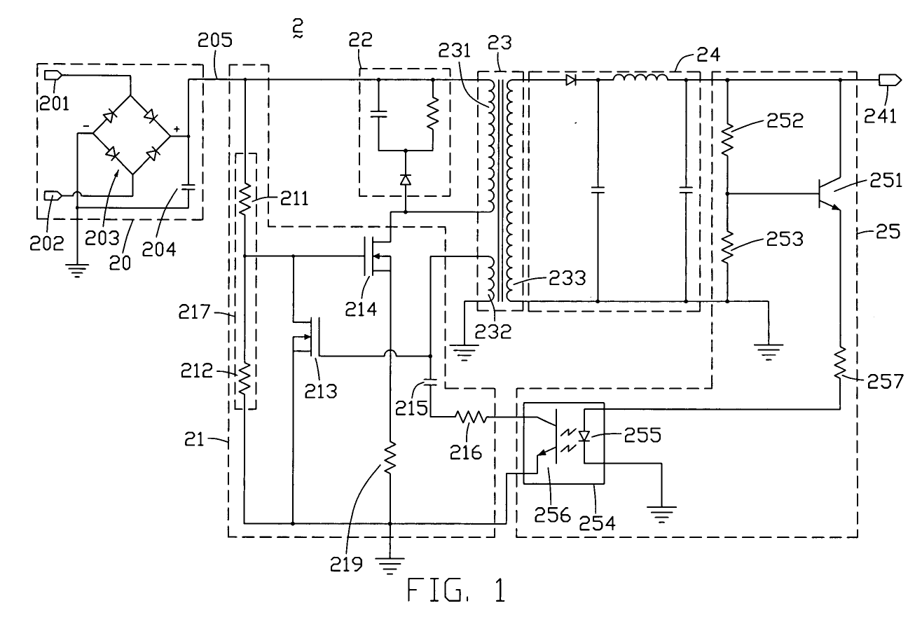

FIG. 1 is a diagram of a switching power supply circuit 2 according to a first embodiment of the disclosure. The switching power supply circuit 2 includes a first rectifying and filtering circuit 20, a pulse generating circuit 21, a protection circuit 22, a transformer 23, and a second rectifying and filtering circuit 24, and a feedback circuit 25.

The first rectifying and filtering circuit 20 includes two inputs 201, 202 to receive an AC voltage such as 220V, a full-bridge rectifying circuit 203 to convert the 220V AC voltage to a first DC voltage, a first filtering capacitor 204 to stabilize the first DC voltage, and a first output 205 to provide the first DC voltage to the transformer 23. Two inputs of the full-bridge rectifying circuit 203 serve as the two inputs 201, 202. A positive output of the full-bridge rectifying circuit 203 serves as the first output 205. A negative output of the full-bridge rectifying circuit 203 is grounded. The first filtering capacitor 204 is connected between the first output 205 and ground.

The pulse generating circuit 21 includes a voltage divider 217 connected between the first output 205 and ground, a first transistor 213, a second transistor 214, an oscillation capacitor 215, and an oscillation resistor 216. The voltage divider 217 includes a first voltage division resistor 211 and a second voltage division resistor 212 connected in series between the first output 205 and ground. A node between the first and the second voltage division resistors 212, 213 is defined as an output of the voltage divider 217 and connected to a gate electrode of the second transistor 214. A drain electrode of the first transistor 213 is connected to the output of the voltage divider 217 and a source electrode of the first transistor 213 is grounded. The first and the second transistors 213, 214 are n-channel metal-oxide-semiconductor field-effect transistors (N-MOSFET).

The transformer 23 includes a primary winding 231, an assistant winding 232, and a secondary winding 233. The primary winding 231 is electrically connected in parallel with the protection circuit 22. One terminal of the primary winding 231 is connected to the first output 205, and the other terminal of the primary winding 231 is connected to a drain electrode of the second transistor 214. A source electrode of the second transistor 214 is grounded via a resistor 219. One terminal of the assistant winding 232 is grounded, and the other terminal of the assistant winding 232 is connected to a gate electrode of the first transistor 213.

The second rectifying and filtering circuit 24 coupled to the secondary winding 233 includes a second output 241 to output a second DC voltage. One terminal of the secondary winding 233 is grounded, and the other terminal of the secondary winding 233 is connected to the second output 241 via the second rectifying and filtering circuit 24.

The feedback circuit 25 includes a third transistor 251, a first bias resistor 252, and a second bias resistor 253, and an optical coupler 254. The optical coupler 254 includes an LED 255 and a photoelectric transistor 256. The first and the second bias resistor 252, 253 are connected in series between the second output 241 and ground. A node between the first and the second bias resistors 252, 253 is connected to a base electrode of the third transistor 251. The second output 241 is grounded via a collector electrode and an emitter electrode of the third transistor 251, a current limiting resistor 257, and the forward biased LED 255 in series. The gate electrode of the first transistor 213 is also grounded via the oscillation capacitor 215, the oscillation resistor 216, and the photoelectric transistor 256 in series. Thus a common emitter amplifier is formed to feedback variation of the DC voltage at the second output 241 to the pulse generating circuit 21 via the optical coupler 254. The third transistor 251 can be npn BJT or an N-MOSFET.

External AC voltage is provided to the two inputs 201, 202 of the first rectifying and filtering circuit 20 and converted to the first DC voltage by the first rectifying and filtering circuit 20. The first DC voltage is provided to the first output 205 to switch the second transistor 214 on via the voltage divider 217. A first current is formed when the first DC voltage provided to the first output 205 is grounded via a first current path. The assistant winding 232 induces the first current and generates an induction voltage to charge the oscillation capacitor 215. When a voltage at the gate electrode of the first transistor 213 increases greater than a switch on voltage of the first transistor 213, the first transistor 213 is switched on. As a result, the second transistor 214 is switched off because the gate electrode of the second transistor 214 is grounded via the activated first transistor 213.

After the second transistor 214 is switched off, the oscillation capacitor 215 is discharged via the assistant winding 232 and the voltage at the gate electrode of the first transistor 213 is decreased. When the voltage at the gate electrode of the first transistor 213 decreases less than the switch on voltage of the first transistor 213, the first transistor 213 is switched off. As a result, the second transistor 214 is switched on because the gate electrode of the second transistor 214 receives the first DC voltage via the voltage divider 217.

The secondary winding 233 induces the first current to generate an AC voltage across the secondary winding 233. The second rectifying and filtering circuit 24 converts the AC voltage across the secondary winding 233 to a second DC voltage, and provides the second DC voltage to the second output 241.

When the second DC voltage at the second output 241 decreases or increases, a second current flowing through the third transistor 251 decreases or increases in accordance with the variation of the second DC voltage. Because the second current can flow through the LED 255 of the optical coupler 254, a third current flowing through the photoelectric transistor 256 of the optical coupler 254 is correspondingly decreased or increases. Thus a charging time of the oscillation capacitor 215 changes according to the variation of second DC voltage, and a duty ratio of a pulse signal generated in the assistant winding 232 changes according to the variation of second DC voltage too. In other words, when the second DC voltage at the second output 241 decreases, the third current flowing through the photoelectric transistor 256 is correspondingly decreases and the charging time of the oscillation capacitor 215 is increased. Thus a period in which the second transistor 214 remains in an activated state is prolonged, and the second DC voltage at the second output 241 is increased. When the DC voltage at the second output 241 increases, the third current flowing through the photoelectric transistor 256 is correspondingly increases and the charging time of the oscillation capacitor 215 is decreased. Thus, a period in which the second transistor 214 remains in an activated state is shortened, and the second DC voltage at the second output 241 is decreased.

The switching power supply circuit 2 employs the pulse generating circuit 21 and the transformer 23 to generate the pulse signal to switch the first transistor 213 on or off. Thus, the switching power supply circuit 2 does not require a PWM chip to control the first and the second transistors 213, 214, resulting in lowered cost and small volume. Furthermore, the feedback circuit 25 of the switching power supply circuit 2 employs the common emitter amplifier to feedback the second DC voltage at the second output 241 to the pulse generating circuit 21 via the optical coupler 254, the switching power supply circuit 2 requires no adjustable precision shunt regulator, resulting in lowered cost and small volume too.

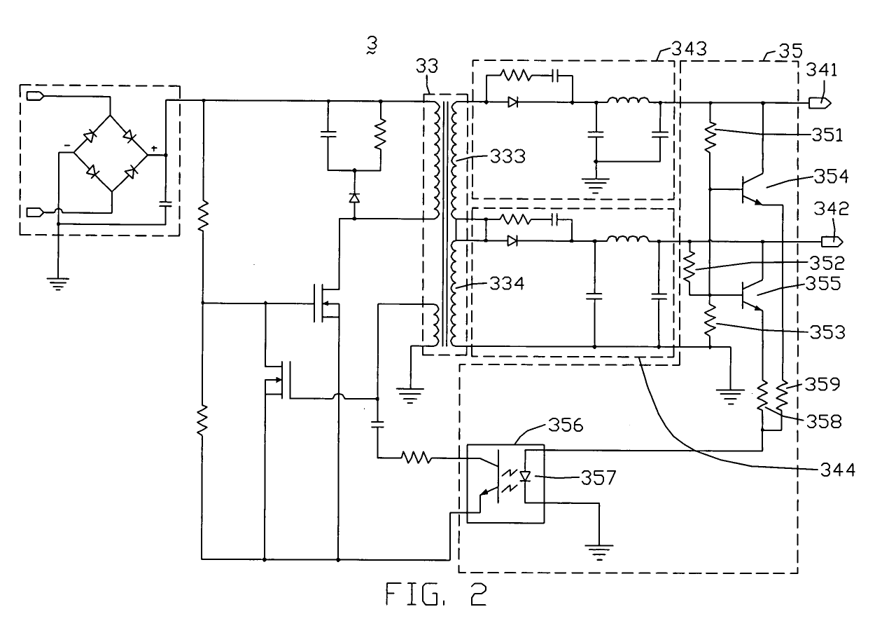

Referring to FIG. 2, a diagram of a switching power supply circuit according to a second embodiment of the disclosure is shown. The switching power supply circuit 3 is similar to the switching power supply circuit 2 except that the switching power supply circuit 3 includes a transformer 33, a second rectifying and filtering circuit 343, a third rectifying and filtering circuit 344, and a feedback circuit 35.

The second rectifying and filtering circuit 343 of the switching power supply circuit 3 includes a second output 341. The third rectifying and filtering circuit 344 of the switching power supply circuit 3 includes a third output 342.

The transformer 33 includes a first secondary winding 333 and a second secondary winding 334. One terminal of the first secondary winding 333 is connected to one terminal of the second secondary winding 334 and to the third output 342 via the third rectifying and filtering circuit 344, and the other terminal of the first secondary winding 333 is coupled to the second output 341 via the second rectifying and filtering circuit 343. The other terminal of the second secondary winding 334 is grounded.

The feedback circuit 35 includes a first, a second and a third bias resistors 351, 352, 353, a third and a fourth transistors 354, 355, two current limiting resistors 358, 359, and an optical coupler 356. The optical coupler 356 includes an LED 357 and a photoelectric transistor (not labeled). Base electrodes of the third and fourth transistors 354, 355 are connected to a reference node. The first bias resistor 351 is connected between the second output 341 and the reference node. The second bias resistor 352 is connected between the third output 342 and the reference node. The third bias resistor 353 is connected between the reference node and ground. The second output 341 is grounded via a collector electrode and an emitter electrode of the third transistor 354, the current limiting resistor 359, and the forward biased LED 357 of the optical coupler 356 in series. The third output 342 is grounded via a collector electrode and an emitter electrode of the fourth transistor 355, the current limiting resistor 358, and the forward biased LED 357 of the optical coupler 356 in series. In summary, a first common emitter amplifier is formed to feedback a second DC voltage at the second output 341 to a pulse generating circuit (not labeled) via the optical coupler 356. A second common emitter amplifier is formed to feedback a third DC voltage at the third output 342 to the pulse generating circuit (not labeled) via the optical coupler 356.

Operation of the switching power supply circuit 3 is similar to the switching power supply circuit 2 except that the switching power supply circuit 3 outputs two regulated DC voltages from the third and the fourth outputs 341, 342, respectively.

It is to be understood, however, that even though numerous characteristics and advantages of certain inventive embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. A switching power supply circuit comprising:
a direct current (DC) power supply input;
a voltage divider connected between the DC power supply input and ground;
a transformer comprising a primary winding, a secondary winding, and an assistant winding;
a pulse generating circuit comprising a first transistor, a second transistor, an oscillation capacitor, and an oscillation resistor, the DC power supply input being grounded via the primary winding, two conducting electrodes of the second transistor, a control electrode of the second transistor being connected to an output of the voltage divider, an output of the voltage divider being grounded via two conducting electrodes of the first transistor, a control electrode of the first transistor being grounded via the assistant winding and grounded via the oscillation capacitor and the oscillation resistor connected in series;
an output coupled to a terminal of the secondary winding to output a DC voltage; and
a feedback circuit comprising a common emitter amplifier and an optical coupler to change a duty ratio of a pulse signal generated in the assistant winding according to variation of DC voltage.

2. The switching power supply circuit of claim 1, further comprising a first rectifying and filtering circuit to receive an external alternating current (AC) voltage and convert the AC voltage to a first DC voltage.

3. The switching power supply circuit of claim 2, wherein the first rectifying and filtering circuit comprises two inputs to receive the external AC voltage, a full-bridge rectifying circuit, a first capacitor, wherein the two inputs of the full-bridge rectifying circuit serve as the two inputs, a positive output of the full-bridge rectifying circuit serving as the DC power supply input, a negative output of the full-bridge rectifying circuit being grounded, and the first capacitor connecting the DC power supply input and ground.

4. The switching power supply circuit of claim 1, wherein the first and the second transistors are n-channel metal-oxide-semiconductor field-effect transistors (MOSFETs).

5. The switching power supply circuit of claim 4, further comprising a first current limiting resistor connected between the second transistor and ground.

6. The switching power supply circuit of claim 5, further comprising a second current limiting resistor connected between an output of the common emitter amplifier and the optical coupler.

7. The switching power supply circuit of claim 2, further comprising a second rectifying and filtering circuit converting an AC voltage across the secondary winding to the second DC voltage, and providing the second DC voltage to the output.

8. A switching power supply circuit comprising:
a direct current (DC) power supply input;
a voltage divider connected between the DC power supply input and ground;
a transformer comprising a primary winding, a first secondary winding, a second secondary winding, and an assistant winding;
a pulse generating circuit comprising a first transistor, a second transistor, an oscillation capacitor, and an oscillation resistor, the DC power supply input being grounded via the primary winding, two conducting electrodes of the second transistor, a control electrode of the second transistor being connected to an output of the voltage divider, an output of the voltage divider being grounded via two conducting electrodes of the first transistor, a control electrode of the first transistor being grounded via the assistant winding and grounded via the oscillation capacitor and the oscillation resistor in series;
a first output and a second output respectively coupled to the first secondary winding and the second secondary winding, the first and the second outputs respectively outputting a first DC voltage and a second DC voltage, and
a feedback circuit comprising a first common emitter amplifier, a second common emitter amplifier, and an optical coupler to change a duty ratio of a pulse signal generated in the assistant winding according to variations of first and the second DC voltages.

9. The switching power supply circuit of claim 8, further comprising a first rectifying and filtering circuit to receive an AC voltage and convert the AC voltage to a third DC voltage.

10. The switching power supply circuit of claim 9, wherein the first rectifying and filtering circuit comprises two inputs to receive the external AC voltage, a full-bridge rectifying circuit, a first capacitor, wherein the two inputs of the full-bridge rectifying circuit serve as the two inputs, a positive output of the full-bridge rectifying circuit serving as the DC power supply input, a negative output of the full-bridge rectifying circuit being grounded, and the first capacitor connecting the DC power supply input and ground.

11. The switching power supply circuit of claim 8, wherein the first and the second transistors are n-channel metal-oxide-semiconductor field-effect transistors (MOSFETs).

12. The switching power supply circuit of claim 8, further comprising a first current limiting resistor connected between the second transistor and ground.

13. The switching power supply circuit of claim 12, further comprising a second current limiting resistor connected between an output of the first common emitter amplifier and the optical coupler.

14. The switching power supply circuit of claim 13, further comprising a third current limiting resistor connected between an output of the second common emitter amplifier and the optical coupler.

15. The switching power supply circuit of claim 8, wherein the first and the second common emitter amplifiers respectively comprises a third transistor and a fourth transistor, base electrodes of the third and the fourth transistors are connected to each other.

16. The switching power supply circuit of claim 10, further comprising a second rectifying and filtering circuit converting an AC voltage across the first secondary winding to the first DC voltage, and providing the first DC voltage to the output.

17. The switching power supply circuit of claim 10, further comprising a second rectifying and filtering circuit converting an AC voltage across the second secondary winding to the second DC voltage, and providing the second DC voltage to the output.
